(19) United States
(12) Patent Application Publication
(10) Pub. No.: US 2025/0385765 A1
(43) Pub. Date: Dec. 18, 2025

(54) PHYSICAL CHANNEL FREQUENCY HOPPING FOR LONG START AND LENGTH INDICATOR VALUE (SLIV)

(71) Applicant: QUALCOMM Incorporated, San Diego, CA (US)

(72) Inventors: Chih-Hao LIU, San Diego, CA (US); Jing SUN, San Diego, CA (US)

(21) Appl. No.: 18/745,671

(22) Filed: Jun. 17, 2024

(51) Int. Cl. H04L 5/00; H04W 72/232

(52) U.S. Cl. CPC H04L 5/0012; H04L 5/0051; H04L 5/0053; H04W 72/232

(57) ABSTRACT

A method for wireless communication at a user equipment (UE), includes receiving, from a network node, a first downlink control information (DCI) message that includes a long start and length indicator value (SLIV) indicating an allocation of physical uplink shared channel (PUSCH) resources to a group of slots. The allocation of PUSCH resources is irrespective of slot boundaries of the group of slots and the PUSCH resources including a set of symbols. The method also includes receiving, from the network node, a first radio resource control (RRC) message configuring a group of frequency hop (FH) intervals associated with the long SLIV. Each FH interval may be associated with a respective subset of symbols of the set of symbols. Additionally, the method includes transmitting, to the network node, uplink data via the allocated PUSCH resources in accordance with the group of FH intervals.

### FIELD OF THE DISCLOSURE

The present disclosure relates generally to wireless communications, and more specifically to physical channel frequency hopping for a long start and length indicator value (SLIV).

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (for example, bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (for example, also known as discrete Fourier transform spread OFDM (DFT-s-OFDM)) on the uplink (UL), as well as supporting beamforming, multiple-input multiple-output (MIMO) antenna technology, and carrier aggregation.

In some wireless communication systems, a UE may receive downlink signaling, such as downlink control information (DCI), that includes an uplink grant for communication. The uplink grant may include a time domain resource assignment that includes an index value configured according to radio resource control (RRC) signaling. The index value may be a start and length indicator value (SLIV) that includes a starting symbol and a transmission duration for transmitting uplink data via a physical uplink shared channel (PUSCH). The SLIV is not limited to uplink transmissions. Downlink transmissions via a physical downlink shared channel (PDSCH) may also be transmitted in accordance with a SLIV. In such wireless communication systems, each SLIV allocates resources, such as PUSCH or PDSCH resources, to a single slot, such that the allocated resources do not cross a slot boundary. In some wireless communication systems, such as 6G and beyond, PUSCH resources and PDSCH resources may not align with respective slot boundaries. In such systems, a long SLIV may allocate PxSCH resources (for example, PUSCH resources or PDSCH resources) across multiple slots irrespective of slot boundaries.

### SUMMARY

In aspects of the present disclosure, a method for wireless communication at a user equipment (UE) includes receiving, from a network node, a first downlink control information (DCI) message that includes a long start and length indicator value (SLIV) indicating an allocation of physical uplink shared channel (PUSCH) resources to a group of slots. The allocation of PUSCH resources may be irrespective of slot boundaries of the group of slots and the PUSCH resources include a set of symbols. The method further includes receiving, from the network node, a first radio resource control (RRC) message configuring a group of frequency hop (FH) intervals associated with the long SLIV. Each FH interval may be associated with a respective subset of symbols of the set of symbols. The method also includes transmitting, to the network node, uplink data via the allocated PUSCH resources in accordance with the group of FH intervals.

Other aspects of the present disclosure are directed to an apparatus. The apparatus includes means for receiving, from a network node, a first DCI message that includes a long SLIV indicating an allocation of PUSCH resources to a group of slots. The allocation of PUSCH resources may be irrespective of slot boundaries of the group of slots and the PUSCH resources include a set of symbols. The apparatus further includes means for receiving, from the network node, a first RRC message configuring a group of FH intervals associated with the long SLIV. Each FH interval may be associated with a respective subset of symbols of the set of symbols. The apparatus also includes means for transmitting, to the network node, uplink data via the allocated PUSCH resources in accordance with the group of FH intervals.

In other aspects of the present disclosure, a non-transitory computer-readable medium with program code recorded thereon is disclosed. The program code is executed by one or more processors and includes program code to receive, from a network node, a first DCI message that includes a long SLIV indicating an allocation of PUSCH resources to a group of slots. The allocation of PUSCH resources may be irrespective of slot boundaries of the group of slots and the PUSCH resources include a set of symbols. The program code further includes program code to receive, from the network node, a first RRC message configuring a group of FH intervals associated with the long SLIV. Each FH interval may be associated with a respective subset of symbols of the set of symbols. The program code also includes program code to transmit, to the network node, uplink data via the allocated PUSCH resources in accordance with the group of FH intervals.

Other aspects of the present disclosure are directed to UE including one or more processors, and one or more memories coupled with the one or more processors and storing processor-executable code that, when executed by the one or more processors, is configured to cause the UE to receive, from a network node, a first DCI message that includes a long SLIV indicating an allocation of PUSCH resources to a group of slots. The allocation of PUSCH resources may be irrespective of slot boundaries of the group of slots and the PUSCH resources include a set of symbols. Execution of the processor-executable code further causes the UE to receive, from the network node, a first RRC message configuring a group of FH intervals associated with the long SLIV. Each FH interval may be associated with a respective subset of symbols of the set of symbols. Execution of the processor-executable code also causes the UE to transmit, to the network node, uplink data via the allocated PUSCH resources in accordance with the group of FH intervals.

In aspects of the present disclosure, a method for wireless communication includes transmitting a first DCI message that includes a long SLIV indicating an allocation of PUSCH resources to a group of slots, the allocation of PUSCH resources being irrespective of slot boundaries of the group of slots, the PUSCH resources including a set of symbols. The method further includes transmitting a first RRC message configuring a group of FH intervals associated with the long SLIV, each FH interval being associated with a respective subset of symbols of the set of symbols. The method also includes receiving, from a UE, uplink data via the allocated PUSCH resources in accordance with the group of FH intervals.

Other aspects of the present disclosure are directed to an apparatus. The apparatus includes means for transmitting a first DCI message that includes a long SLIV indicating an allocation of PUSCH resources to a group of slots, the allocation of PUSCH resources being irrespective of slot boundaries of the group of slots, the PUSCH resources including a set of symbols. The apparatus further includes means for transmitting a first RRC message configuring a group of FH intervals associated with the long SLIV, each FH interval being associated with a respective subset of symbols of the set of symbols. The apparatus also includes means for receiving, from a UE, uplink data via the allocated PUSCH resources in accordance with the group of FH intervals.

In other aspects of the present disclosure, a non-transitory computer-readable medium with program code recorded thereon is disclosed. The program code is executed by one or more processors and includes program code to transmit a first DCI message that includes a long SLIV indicating an allocation of PUSCH resources to a group of slots, the allocation of PUSCH resources being irrespective of slot boundaries of the group of slots, the PUSCH resources including a set of symbols. The program code further includes program code to transmit a first RRC message configuring a group of FH intervals associated with the long SLIV, each FH interval being associated with a respective subset of symbols of the set of symbols. The program code also includes program code to receive, from a UE, uplink data via the allocated PUSCH resources in accordance with the group of FH intervals.

Other aspects of the present disclosure are directed to network node including one or more processors, and one or more memories coupled with the one or more processors and storing processor-executable code that, when executed by the one or more processors, is configured to cause the network node to transmit a first DCI message that includes a long SLIV indicating an allocation of PUSCH resources to a group of slots, the allocation of PUSCH resources being irrespective of slot boundaries of the group of slots, the PUSCH resources including a set of symbols. Execution of the processor-executable code also causes the network node to transmit a first RRC message configuring a group of FH intervals associated with the long SLIV, each FH interval being associated with a respective subset of symbols of the set of symbols. Execution of the processor-executable code further causes the network node to receive, from a UE, uplink data via the allocated PUSCH resources in accordance with the group of FH intervals.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 is a timing diagram illustrating an example of communicating in accordance with a group of frequency hopping intervals, in accordance with various aspects of the present disclosure.

FIG. 5 is a block diagram illustrating an example of a group of frequency hopping intervals, in accordance with various aspects of the present disclosure.

FIG. 6 is a block diagram illustrating an example of sub-frequency hopping intervals, in accordance with various aspects of the present disclosure.

FIG. 7 is a block diagram illustrating an example of a group of frequency hopping intervals that are irrespective of gaps or invalid symbols, in accordance with various aspects of the present disclosure.

FIG. 8 is a block diagram illustrating an example wireless communication device that supports frequency hopping intervals, in accordance with various aspects of the present disclosure.

FIG. 9 is a flow diagram illustrating an example of a process for frequency hopping across physical uplink shared channel (PUSCH) resources allocated by a long start and length indicator value (SLIV), in accordance with various aspects of the present disclosure.

FIG. 10 is a block diagram illustrating an example wireless communication device that supports frequency hopping intervals, in accordance with various aspects of the present disclosure.

FIG. 11 is a flow diagram illustrating an example of a process for configuring frequency hopping across PUSCH resources allocated by a long SLIV, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

In some wireless communication systems, a user equipment (UE) may receive downlink signaling, such as downlink control information (DCI), that includes an uplink grant for communication. The uplink grant may include a time domain resource assignment that includes an index value configured according to radio resource control (RRC) signaling. The index value may be a start and length indicator value (SLIV) that includes a starting symbol and a transmission duration for transmitting uplink data via a physical uplink shared channel (PUSCH). The SLIV is not limited to uplink transmissions. Downlink transmissions via a physical downlink shared channel (PDSCH) may also be transmitted in accordance with a SLIV. In such wireless communication systems, each SLIV allocates resources, such as PUSCH or PDSCH resources, to a single slot, such that the allocated resources are aligned with a slot boundary. The respective slot boundaries may be used to coordinate frequency hopping, such as inter-slot frequency hopping, inter-nominal frequency hopping, or intra-slot frequency hopping.

Inter-slot frequency hopping refers to changing a carrier frequency between consecutive slots in a time-division multiplexed (TDM) communication system. In such examples, the transmitter switches to a different frequency at each slot. Intra-slot frequency hopping refers to changing a carrier frequency within a duration of a slot. Inter-nominal frequency hopping refers to changing a carrier frequency between different nominal transmission instances, such as different repetition instances across two or more slots. As an example, a carrier frequency may change between repetition instances of a group of repetition instances across two or more slots. The repetitions may be type-B repetitions. As another example, a first set of repetitions associated with a first transmission may be associated with a first carrier frequency and a second set of repetitions associated with a second transmission may be associated with a second carrier frequency.

In conventional PUSCH repetitions, such as PUSCH repetitions for fifth generation (5G) wireless communication systems, network nodes may ensure that there are one or more demodulation reference signal (DMRS) symbols within each slot. Because each slot may be associated with a frequency hop segment, the inclusion of one or more DMRS symbols within each slot facilitates robust channel estimates because the channel estimates may be performed across various frequency hops. Additionally, the legacy new radio (NR) standard specifies that one or more DMRSs should be included in each slot regardless of whether the frequency hopping is inter-slot or inter-nominal. Furthermore, the legacy NR standard stipulates that if intra-slot frequency hopping is implemented, at least one DMRS symbol is to be included within each hopping segment.

In some wireless communication systems, such as sixth generation (6G) and beyond, a long SLIV may allocate PxSCH resources (for example, PUSCH resources or PDSCH resources) to a group of slots. In such systems, the PxSCH resources are allocated irrespective of slot boundaries. The lack of distinct slot boundaries introduces various challenges when implementing frequency hopping, such as inter-slot frequency hopping, inter-nominal frequency hopping, and intra-slot frequency hopping. These challenges include, but are not limited to, determining how to partition the long SLIV to accommodate frequency hopping and determining a number of carrier frequencies that may be specified for the frequency hopping within the long SLIV. For example, the number of supported carrier frequencies should support both inter-slot and intra-slot frequency hopping.

Various aspects of the present disclosure are directed to supporting frequency hopping in PxSCH resources allocated in accordance with a long SLIV. In some examples, a network node may configure a group of frequency hopping intervals to support frequency hopping across PxSCH resources allocated in accordance with the long SLIV. In such examples, a network node may transmit, to a UE, downlink control information (DCI) that includes a long SLIV indicating an allocation of PxSCH resources to a group of slots. In a conventional SLIV, a conventional allocation of PxSCH resources aligns a set of symbols to a slot boundary. In contrast, for the long SLIV, the allocation of the PxSCH resources is irrespective of slot boundaries of the group of slots. Therefore, a set of symbols associated with the PxSCH may span across the group of slots, irrespective of respective slot boundaries of the group of slots. After allocating the PxSCH resources in accordance with the long SLIV, the network node may then transmit a radio resource control (RRC) message configuring the group of frequency hopping intervals associated with the long SLIV. Each frequency hopping interval of the group of frequency hopping intervals may be associated with a respective subset of symbols of the set of symbols associated with the PxSCH resources. In some examples, adjacent frequency hopping intervals of the group of frequency hopping intervals are separated by a gap, such as a logical gap or a physical gap. Examples of physical gaps include, but are not limited to, a slot boundary, an uplink/downlink symbol, or a transmit/receive switching gap. Examples of logical gaps include, but are not limited to, a gap in phase continuity or a transport block boundary. In other examples, the group of frequency hopping intervals are allocated irrespective of gaps or invalid symbols. In some examples, each one of the group of frequency hopping intervals may be associated with a carrier frequency of a group of carrier frequencies, such that adjacent frequency hopping intervals are associated with different respective carrier frequencies. Finally, the network node may transmit or receive data via the allocated PxSCH resources in accordance with the group of frequency hopping intervals.

Particular aspects of the subject matter described in this disclosure can be implemented to realize one or more of the following potential advantages. In some examples, the described techniques of configuring a group of frequency hopping intervals enables a network node to partition a long SLIV when the PxSCH resources are allocated irrespective of slot boundaries. In some examples, partitioning the long SLIV into the group of frequency hopping intervals may enable frequency hopping across PxSCH resources allocated in accordance with the long SLIV. In such examples, enabling frequency hopping across PxSCH resources may improve transmission quality because the network node or UE may cycle through various frequencies to mitigate interface. Additionally, partitioning the long SLIV into the group of frequency hopping intervals may enable the network node to allocate one or more respective DMRS symbols within each frequency hopping interval. Allocating the one or more respective DMRS symbols within each frequency hopping interval may improve channel estimates because a UE may obtain channel estimates across various carrier frequencies associated with the group of frequency hopping intervals.

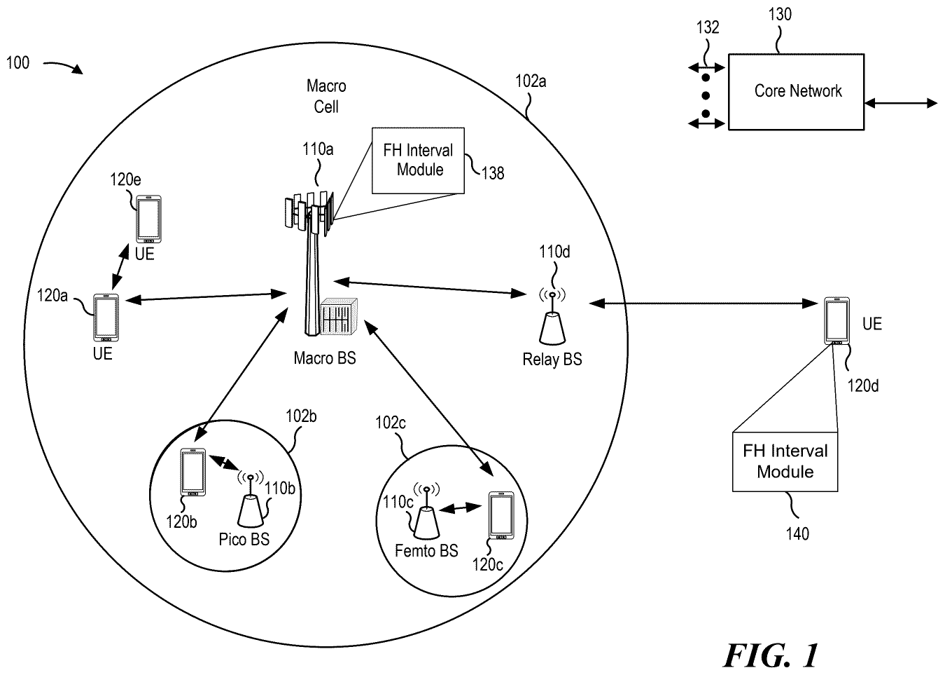

FIG. 1 is a diagram illustrating a wireless network 100 in which aspects of the present disclosure may be practiced. The wireless network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (for example, three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (for example, a BS or a UE) and send a transmission of the data to a downstream station (for example, a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (for example, macro BSs, pico BSs, femto BSs, relay BSs, and/or the like). These different types of BSs may have different transmit power levels, different coverage areas, and different impact on interference in the wireless network 100. For example, macro BSs may have a high transmit power level (for example, 5 to 40 watts) whereas pico BSs, femto BSs, and relay BSs may have lower transmit power levels (for example, 0.1 to 2 watts).

As an example, the BSs 110 (shown as BS 110a, BS 110b, BS 110c, and BS 110d) and the core network 130 may exchange communications via backhaul links 132 (for example, S1, etc.). Base stations 110 may communicate with one another over other backhaul links (for example, X2, etc.) either directly or indirectly (for example, through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (for example, S1, S2, etc.) and may perform radio configuration and scheduling for communications with the UEs 120. In some configurations, various functions of each access network entity or base station 110 may be distributed across various network devices (for example, radio heads and access network controllers) or consolidated into a single network device (for example, a base station 110).

UEs 120 (for example, 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (for example, smart ring, smart bracelet)), an entertainment device (for example, a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

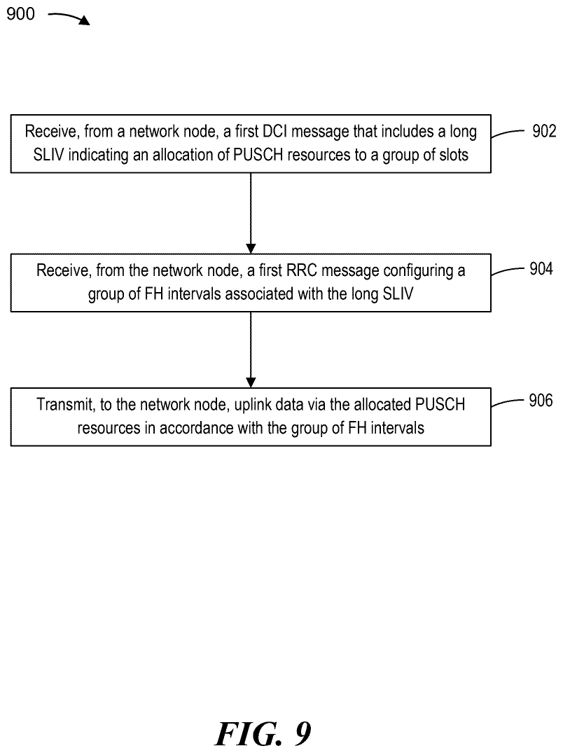

The UEs 120 may include a frequency hopping (FH) interval module 140. For brevity, only one UE 120d is shown as including the FH interval module 140. The FH interval module 140 may perform one or more operations, such as operations associated with a process 900 described with reference to FIG. 9.

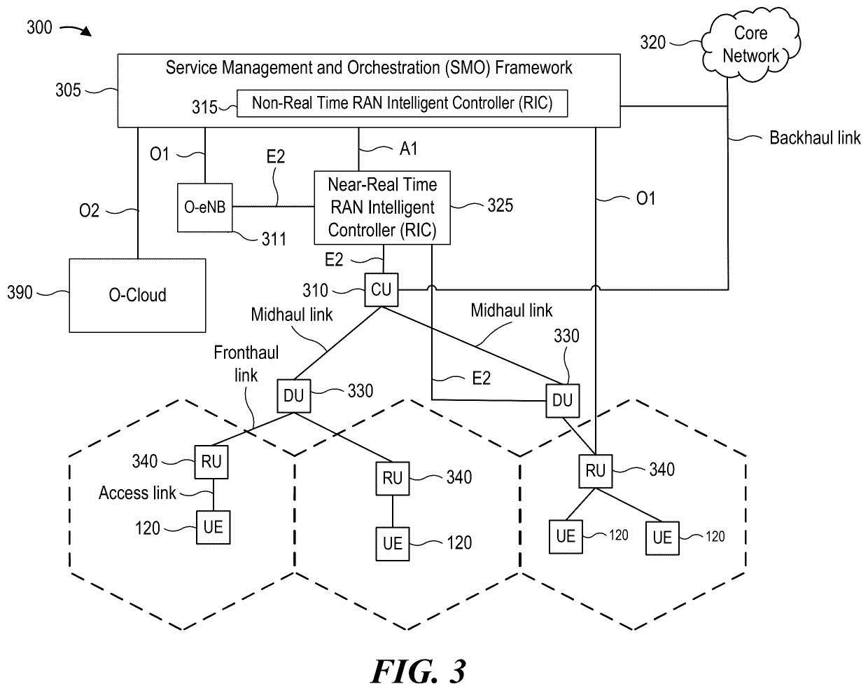

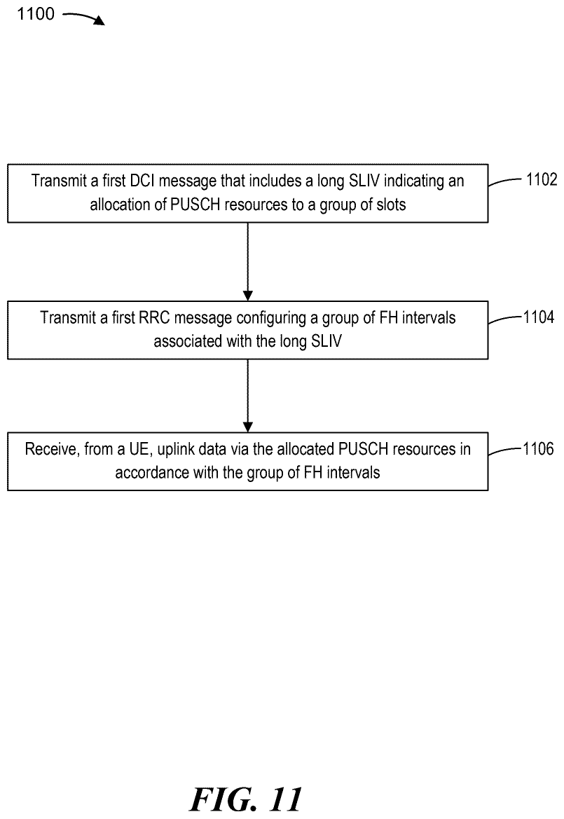

The core network 130 or the base stations 110 or any other network device (for example, as seen in FIG. 3) may include a FH interval module 138. The FH interval module 138 may perform one or more operations, such as operations associated with a process 1100 described with reference to FIG. 11.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (for example, remote device), or some other entity. A wireless node may provide, for example, connectivity for or to a network (for example, a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (for example, a system information block (SIB).

As indicated above, FIG. 1 is provided merely as an example. Other examples may differ from what is described with regard to FIG. 1.

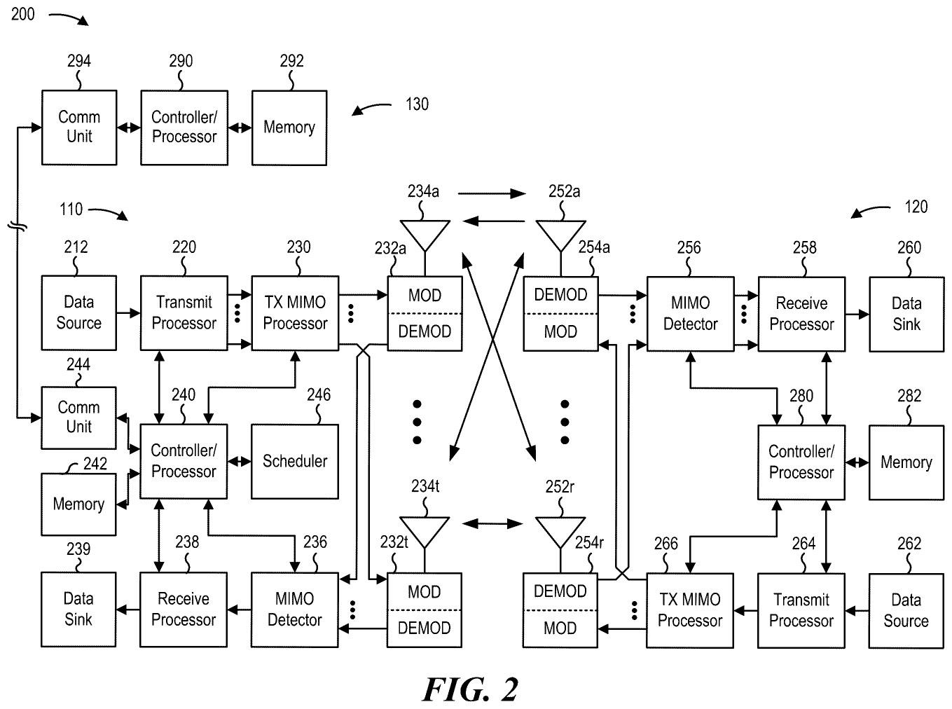

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (for example, encode and modulate) the data for each UE based at least in part on the MCS(s) selected for the UE, and provide data symbols for all UEs. Decreasing the MCS lowers throughput but increases reliability of the transmission. The transmit processor 220 may also process system information (for example, for semi-static resource partitioning information (SRPI) and/or the like) and control information (for example, CQI requests, grants, upper layer signaling, and/or the like) and provide overhead symbols and control symbols. The transmit processor 220 may also generate reference symbols for reference signals (for example, the cell-specific reference signal (CRS)) and synchronization signals (for example, the primary synchronization signal (PSS) and secondary synchronization signal (SSS)). A transmit (TX) multiple-input multiple-output (MIMO) processor 230 may perform spatial processing (for example, precoding) on the data symbols, the control symbols, the overhead symbols, and/or the reference symbols, if applicable, and may provide T output symbol streams to T modulators (MODs) 232a through 232t. Each modulator 232 may process a respective output symbol stream (for example, for orthogonal frequency division multiplexing (OFDM) and/or the like) to obtain an output sample stream. Each modulator 232 may further process (for example, convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (for example, filter, amplify, downconvert, and digitize) a received signal to obtain input samples. Each demodulator 254 may further process the input samples (for example, for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (for example, demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (for example, for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (for example, for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

The controller/processor 240 of the base station 110, the controller/processor 280 of the UE 120, and/or any other component(s) of FIG. 2 may perform one or more techniques associated with configuring a group of frequency hopping intervals for PxSCH resources allocated in accordance with a long SLIV as described in more detail elsewhere. For example, the controller/processor 240 of the base station 110, the controller/processor 280 of the UE 120, and/or any other component(s) of FIG. 2 may perform or direct operations of, for example, the processes of FIGS. 9 and 11 and/or other processes as described. Memories 242 and 282 may store data and program codes for the base station 110 and UE 120, respectively. A scheduler 246 may schedule UEs for data transmission on the downlink and/or uplink.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (for example, a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (for example, the CUS 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (for example, central unit-user plane (CU-UP)), control plane functionality (for example, central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as A1 policies).

In some wireless communication systems, such as 6G and beyond, a long SLIV may allocate PxSCH resources (for example, PUSCH resources or PDSCH resources) to a group of slots. In such systems, the PxSCH resources are allocated irrespective of slot boundaries. The lack of distinct slot boundaries introduces various challenges when implementing frequency hopping, such as inter-slot frequency hopping, inter-nominal frequency hopping, and intra-slot frequency hopping. These challenges include, but are not limited to, determining how to partition the long SLIV to accommodate frequency hopping and determining a number of carrier frequencies that may be specified for the frequency hopping within the long SLIV. For example, the number of supported carrier frequencies should support both inter-slot and intra-slot frequency hopping.

In some wireless communication systems, intra-slot frequency hopping is specified when, for a given slot, a PUSCH is transmitted with a specific number of symbols. For example, for a slot where the PUSCH uses N symbols, half of these symbols, └N/2┘, are allocated for the first frequency hop, while the remaining symbols are used for a second hop. A starting position of the first hop within the slot is determined by a parameter RBₛₜₐᵣₜ and a second hop is defined by an offset from the first:

$${RB}_{start} = \{ \begin{matrix}{RB}_{start} & i = 0 \\ ( {RB}_{start} + {RB}_{offset} ) mod {N}_{BWP}^{size} & i = 1\end{matrix} . \qquad ( 1 )$$

Intra-slot frequency hopping may be used for both single slot and multi-slot PUSCH transmissions.

For inter-slot frequency hopping, a starting resource block (RB) during a slot

$${n}_{s}^{u}$$

is given by:

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} . \qquad ( 2 )$$

In Equation 2,

$${n}_{s}^{u}$$

represents a slot number,

$${N}_{BWP}^{size}$$

represents a size of a bandwidth part, and RB_{offset} represents a frequency offset in RBs between the two frequency hops. In the case of inter-slot frequency hopping, when PUSCH-DMRS-Bundling is enabled, and when a PUSCH is not scheduled by a random access response (RAR) uplink (UL) grant or DCI format 0_0 with cyclic redundancy check (CRC) scrambled by a temporary cell radio network temporary identifier (TC-RNTI), the starting RB during slot is given by an equation that is different than Equation 2.

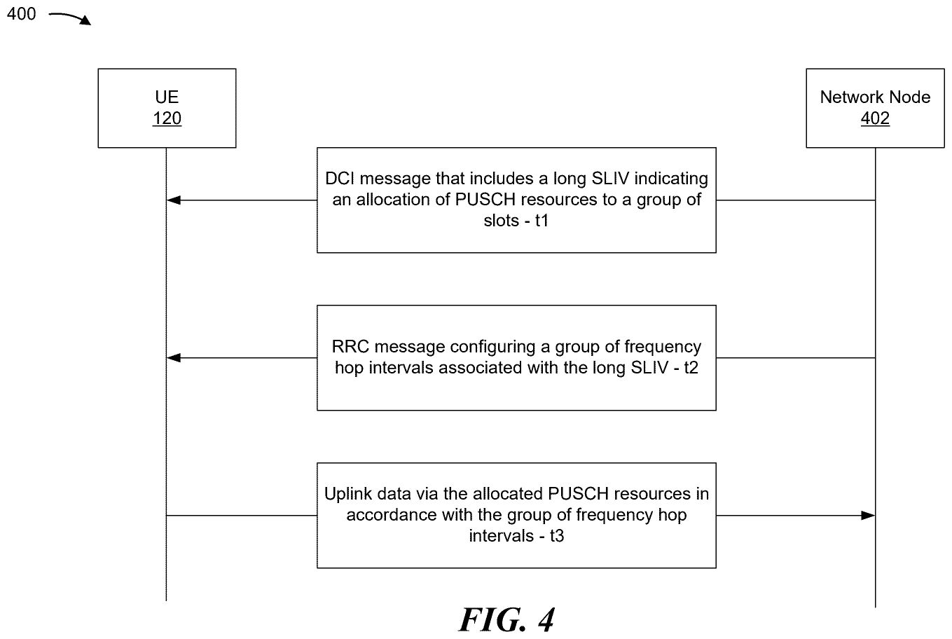

Various aspects of the present disclosure are directed to supporting frequency hopping in PxSCH resources allocated in accordance with a long SLIV. In some examples, a frequency hopping interval parameter may support frequency hopping across PxSCH resources allocated in accordance with the long SLIV. FIG. 4 is a timing diagram illustrating an example 400 of communicating in accordance with a group of frequency hopping intervals, in accordance with various aspects of the present disclosure. As shown in the example of FIG. 4, a UE 120 may communicate with a network node 402. The network node 402 may be an example of a base station 110 as described with reference to FIGS. 1 and 2, or a CU 310, DU 330, or RU 340 as described with reference to FIG. 3.

In the example of FIG. 4, at time t1, the UE 120 may receive, from the network node 402, a DCI message that includes a long SLIV indicating an allocation of PUSCH resources to a group of slots. The allocation of PUSCH resources may be irrespective of slot boundaries of the group of slots. The PUSCH resources may include a set of symbols (for example, multiple groups of symbols). At time t2, the UE 120 may receive, from the network node 402, an RRC message configuring a group of frequency hopping intervals associated with the long SLIV. Furthermore, at time t3, the UE 120 may transmit, to the network node 402, uplink data via the allocated PUSCH resources in accordance with the group of frequency hopping intervals. Each subset of symbols of the set of symbols may be associated with a respective frequency hopping interval of the group of frequency hopping intervals. Various aspects of the present disclosure are not limited to PUSCH resources, the long SLIV may indicate an allocation of PDSCH resources to a group of slots.

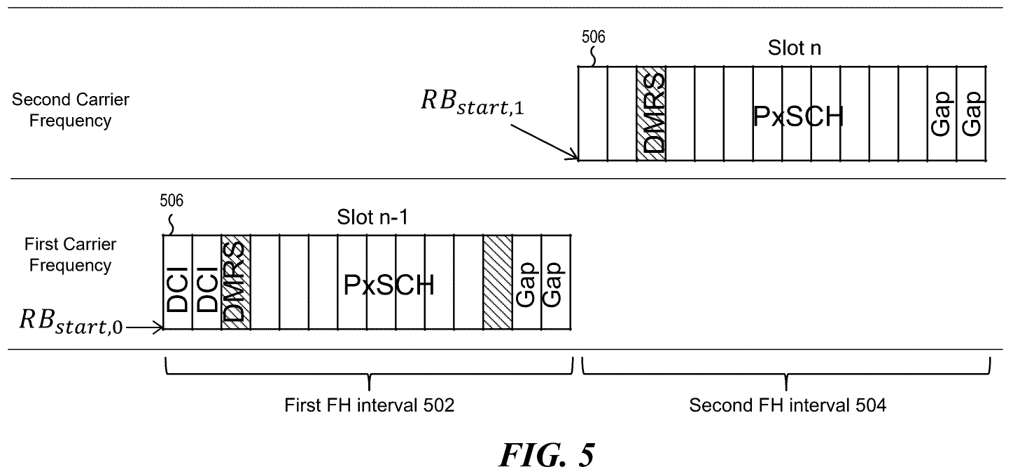

As discussed with respect to the example 400 of FIG. 4, a group of frequency hopping intervals may be associated with the long SLIV. Additionally, each frequency hopping interval of the group of frequency hopping intervals may be associated with a respective subset of symbols of the set of symbols. FIG. 5 is a block diagram illustrating an example of a group of frequency hopping intervals 502 and 504, in accordance with various aspects of the present disclosure. In the example of FIG. 5, a long SLIV may be associated with a first frequency hopping interval 502 for a first carrier frequency and a second frequency hopping interval 504 for a second carrier frequency. Because the first and second frequency hopping intervals 502 and 504 are adjacent, the first carrier frequency is different than the second carrier frequency. In the example of FIG. 5, RB_{start,0} represents an initial resource block (RB) of the first frequency hopping interval 502 and RB_{start,1} represents an initial RB of the second frequency hopping interval 504.

Each frequency hopping interval 502 and 504 may be associated with a respective subset of symbols (for ease of explanation, only one symbol 506 of each subset of symbols is labeled for the frequency hopping intervals 502 and 504). Each symbol may be allocated to a channel resource, such as, but not limited to, a PxSCH resource, such as a PUSCH resource or a PDSCH resource, a gap, DCI, or a DMRS. Additionally, as shown in the example of FIG. 5, the first frequency hopping interval 502 may correspond with a first slot (slot n−1), and the second frequency hopping interval 504 may correspond with a second slot (slot n). Aspects of the present disclosure are not limited to dividing the long SLIV into two frequency hopping intervals 502 and 504.

In the example of FIG. 5, each frequency hopping interval 502 and 504 is aligned with a gap, such as a physical gap or a logical gap. Examples of physical gaps include, but are not limited to, a slot boundary, an uplink/downlink symbol, or a transmit/receive switching gap. Examples of logical gaps include but are not limited to, a gap in phase continuity or a transport block boundary. As shown in the example of FIG. 5, the last two symbols of each frequency hopping interval 502 and 504 are gap symbols. These gaps divide the long SLIV into multiple time segments, where each time segment corresponds to a subset of symbols. In most cases, channel estimation occurs every time segment. Additionally, channel estimation may be specified when a physical shared channel (PxSCH) hops to a new frequency. In some examples, a DMRS pattern may include one or more DMRS symbols in each time segment. In some examples, a code block (CB) and its corresponding code block group (CBG) may be self-contained within one time segment. In some such examples, the CB and CBG may remain on the same frequency.

As discussed, in some examples, frequency hopping intervals may align with a gap boundary. In some cases, the frequency hopping intervals may vary in size and are separated by the gap boundaries (for example, logical gap boundaries or physical gap boundaries). In some cases, a slot gap may be considered. In such cases, such as the example described with respect to FIG. 5, each frequency hopping interval corresponds to one slot, resulting in slot-based hopping for the long SLIV.

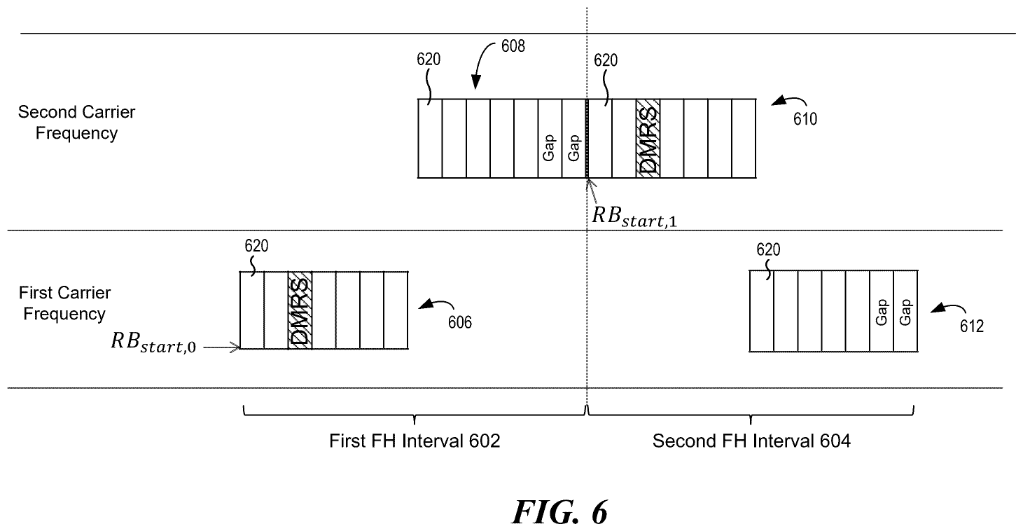

In some examples, to improve frequency diversity for a transport block (TB) transmission, frequency hopping may be specified within each of the frequency hopping intervals (for example, time segments), which are delineated by gaps. Frequency hopping within each frequency hopping interval may occur on sub-frequency hopping intervals. FIG. 6 is a block diagram illustrating an example of sub-frequency hopping intervals, in accordance with various aspects of the present disclosure. In the example of FIG. 6, RB_{start,0} represents an initial resource block (RB) of a first frequency hopping interval 602 and RB_{start,1} represents an initial RB of a second frequency hopping interval 604. Each frequency hopping interval 602 and 604 is delineated by a set of gap symbols (shown as “gap”). In other examples (not shown in the example of FIG. 6), the frequency hopping intervals 602 and 604 are not separated by gaps. Each frequency hopping interval 602 and 604 may be associated with a respective subset of symbols (for ease of explanation, only some symbols 620 of the respective subset of symbols are labeled for each frequency hopping interval 602 and 604). In some examples, the first frequency hopping interval 602 may be associated with a first slot (for example, slot n−1) and the second frequency hopping interval 604 may be associated with a second slot (for example, slot n).

As shown in the example of FIG. 6, the first frequency hopping interval 602 includes a first sub-frequency hopping interval 606 associated with a first carrier frequency and a second sub-frequency hopping interval 608 associated with a second carrier frequency. Additionally, the second frequency hopping interval 604 includes a third sub-frequency hopping interval 610 associated with the second carrier frequency and a fourth sub-frequency hopping interval 612 associated with the first carrier frequency. Aspects of the present disclosure are not limited to each frequency hopping interval 602 and 604 including two sub-frequency hopping intervals. In some examples, a quantity of sub-frequency hopping intervals may be pre-configured (for example, configured via control signaling) to increase frequency diversity gain. In such examples, the frequency diversity gain may increase when there are no prior channel state information (CSI) transmissions. In some examples, the quantity of sub-frequency hopping intervals may be a function of a quantity of frequency hop carrier frequencies, such that each frequency hop carrier frequency is visited an equal number of times.

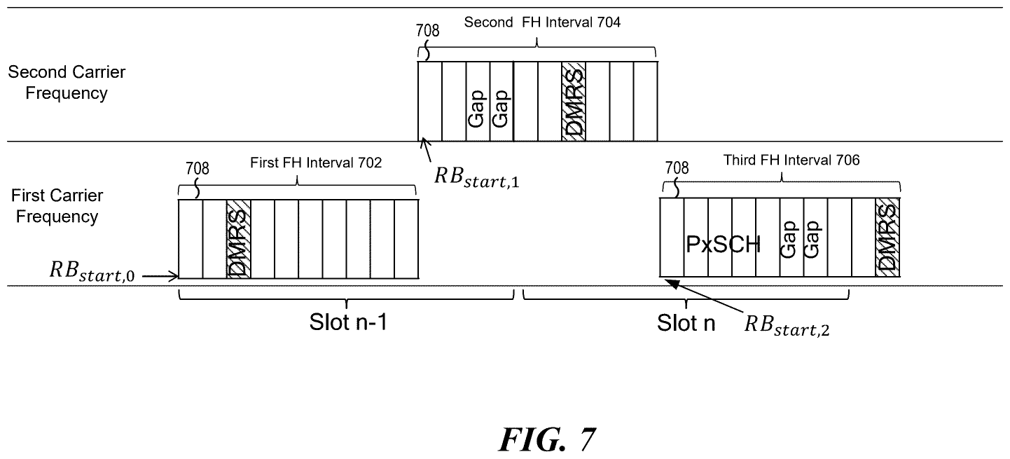

In some examples, the long SLIV may be partitioned into a group of frequency hopping intervals that are irrespective of gaps or invalid symbols. FIG. 7 is a block diagram illustrating an example of a group of frequency hopping intervals that are irrespective of gaps or invalid symbols, in accordance with various aspects of the present disclosure. In the example of FIG. 7, a long SLIV may be associated with a first frequency hopping interval 702, a second frequency hopping interval 704, and a third frequency hopping interval 706. Each frequency hopping interval 702, 704, and 706 may be associated with a respective subset of symbols (for example, group of symbols) (for ease of explanation, only one symbol 708 of each subset of symbols is labeled for the frequency hopping intervals 702, 704, and 706). In the example of FIG. 7, the frequency hopping intervals 702, 704, and 706 are configured irrespective of slot boundaries (for example, a boundary between slot n−1 and slot n), gaps (for example, logical gaps or physical gaps), and/or invalid symbols. In some such examples, each frequency hopping interval 702, 704, and 706 has a same duration. That is, each subset of symbols may have a same duration. Furthermore, in some examples, a UE may receive, from a network node, a message indicating a quantity of frequency hopping intervals (for example, a quantity of the groups of symbols). The message may be a DCI message or an RRC message. If the quantity of frequency hopping intervals is RRC configured, the quantity of frequency hopping intervals may be based on one or more parameters, such as, but not limited to, one or more of a length of the SLIV, frequency domain resource allocation (FDRA), a modulation and coding scheme (MCS), a number of layers, or other relevant parameters.

In some other examples, the long SLIV may be associated with a group of frequency hopping intervals, in which the respective frequency hopping intervals do not have the same duration. In such examples, similar to the example described with reference to FIG. 7, the group of frequency hopping intervals may be partitioned irrespective of slot boundaries, gaps, and/or invalid symbols. In such examples, a UE may receive, from a network node, a message indicating the duration of each frequency hopping interval (for example, each group of symbols). The message may be a DCI message or an RRC message. If the duration of frequency hopping intervals is RRC configured, the duration of frequency hopping intervals may be based on one or more parameters, such as, but not limited to, one or more of a length of the SLIV, frequency domain resource allocation (FDRA), a modulation and coding scheme (MCS), a number of layers, or other relevant parameters. In some such examples, the UE may also receive signaling indicating a quantity of frequency hopping intervals.

As discussed, in some examples, a group of frequency hopping intervals may be partitioned irrespective of slot boundaries, gaps, and/or invalid symbols. In some such examples, a length of a frequency hopping interval is not adjusted if the frequency hopping interval overlaps one or more gap symbols or invalid symbols. Specifically, in such examples, a number of symbols in a subset of symbols associated with the frequency hope interval may be maintained regardless of whether one or more respective symbols in the subset of symbols are associated with a gap or an invalid symbol. The subset of symbols may also be referred to as a group of symbols.

In other such examples, a length of a first frequency hopping interval may be adjusted based on a number of symbols that overlap a gap symbol or an invalid symbol. Furthermore, a length of an adjacent frequency hopping interval may be adjusted to account for the adjustment to the length of the first frequency hopping interval. In such examples, each frequency hopping interval may have a same number of valid symbols (for example, symbols that do not overlap a gap symbol or invalid symbol). Specifically, in such examples, a quantity of symbols in each of the group of symbols associated with the frequency hopping intervals may be adjusted, such that each group of symbols has a same quantity of valid symbols. The adjustment may be based on one or more respective symbols of at least one of the multiple groups of symbols having a gap symbol or an invalid symbol.

In some examples, a DMRS pattern may be jointly configured with a frequency hopping interval configured to ensure a sufficient amount of DMRS symbols for channel estimation in each frequency hopping interval. In some such examples, the DMRS pattern may be configured per frequency hopping interval. In such examples, a location and quantity of DMRS symbols may be determined for each frequency hopping interval. The location and quantity may depend on the SLIV of each frequency hopping interval. In such examples, one or more DMRS symbols are included in each frequency hopping interval.

In other examples, the DMRS pattern and frequency hopping intervals are jointly configured to enable channel estimation in each frequency hopping interval. In such examples, compatible DMRS patterns and frequency hopping intervals are selected. For example, when a network node configures a DMRS pattern and frequency hopping intervals, the network node selects a particular DMRS pattern that accommodates the desired frequency hopping intervals, or vice versa.

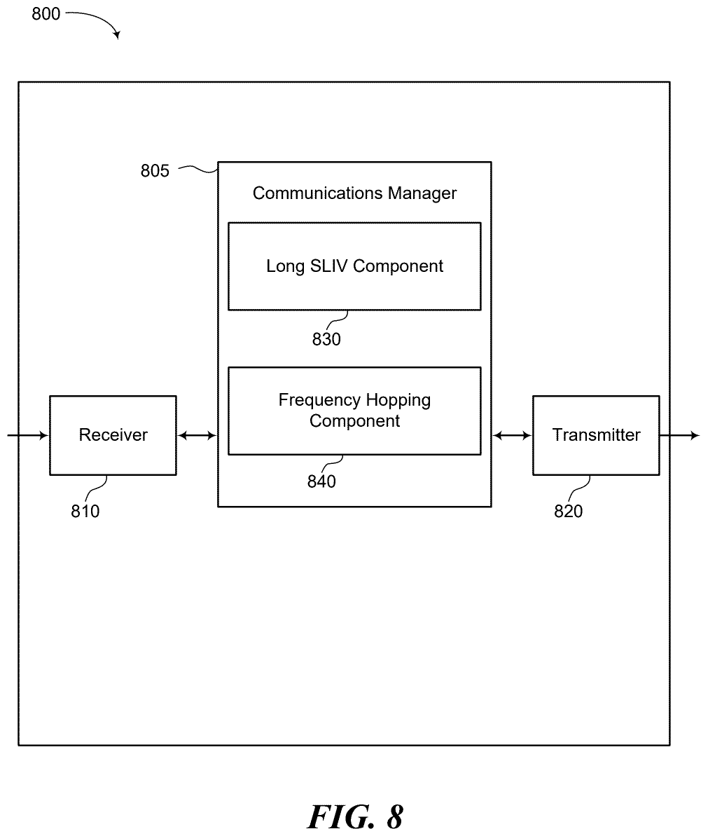

FIG. 8 is a block diagram illustrating an example wireless communication device 800 that supports frequency hopping intervals, in accordance with various aspects of the present disclosure. The wireless communication device 800 may be an example of aspects of a UE 120 described with respect to FIGS. 1, 2, and 4. The wireless communication device 800 may include a receiver 810, a communications manager 805, a transmitter 820, a long SLIV component 830, and a frequency hopping component 840, which may be in communication with one another (for example, via one or more buses). In some examples, the wireless communication device 800 is configured to perform operations, including operations of the process 900 described below with reference to FIG. 9.

In some examples, the wireless communication device 800 can include a chip, chipset, package, or device that includes at least one processor and at least one modem (for example, a 5G modem or other cellular modem). In some examples, the communications manager 805, or its sub-components, may be separate and distinct components. In some examples, at least some components of the communications manager 805 are implemented at least in part as software stored in a memory. For example, portions of one or more of the components of the communications manager 805 can be implemented as non-transitory code executable by the processor to perform the functions or operations of the respective component.

The receiver 810 may receive one or more of reference signals (for example, periodically configured channel state information-reference signals (CSI-RSs), aperiodically configured CSI-RSs, or multi-beam-specific reference signals), synchronization signals (for example, synchronization signal blocks (SSBs)), control information and data information, such as in the form of packets, from one or more other wireless communication devices via various channels including control channels (for example, a physical downlink control channel (PDCCH), or physical shared control channel (PSCCH)) and data channels (for example, a PDSCH, PSSCH). The other wireless communication devices may include, but are not limited to, a base station 110 described with reference to FIGS. 1 and 2, a DU 330, an RU 340, or a CU 310 described with reference to FIG. 3, or a network node 400 described with reference to FIG. 4.

The received information may be passed on to other components of the wireless communication device 800. The receiver 810 may be an example of aspects of the receive processor 258 described with reference to FIG. 2. The receiver 810 may include a set of radio frequency (RF) chains that are coupled with or otherwise utilize a set of antennas (for example, the set of antennas may be an example of aspects of the antennas 252 described with reference to FIG. 2).

The transmitter 820 may transmit signals generated by the communications manager 805 or other components of the wireless communication device 800. In some examples, the transmitter 820 may be collocated with the receiver 810 in a transceiver. The transmitter 820 may be an example of aspects of the transmit processor 264 described with reference to FIG. 2. The transmitter 820 may be coupled with or otherwise utilize a set of antennas (for example, the set of antennas may be an example of aspects of the antennas 252 described with reference to FIG. 2), which may be antenna elements shared with the receiver 810. In some examples, the transmitter 820 is configured to transmit control information in a physical uplink control channel (PUCCH) or PSCCH, and data in a physical uplink shared channel (PUSCH) or PSSCH.

The communications manager 805 may be an example of aspects of the controller/processor 280 described with reference to FIG. 2. The communications manager 805 may include the long SLIV component 830, and a frequency hopping component 840. In some examples, working in conjunction with the receiver 810, the long SLIV component 830 receives, from a network node, a first DCI message that includes a long SLIV indicating an allocation of PUSCH resources to a group of slots. The allocation of PUSCH resources is irrespective of slot boundaries of the group of slots and the PUSCH resources include a set of symbols. Additionally, working in conjunction with the receiver 810, the frequency hopping component 840 receives, from the network node, a first RRC message configuring a group of FH intervals associated with the long SLIV. Each FH interval may be associated with a respective subset of symbols of the set of symbols. Additionally, working in conjunction with one or both of the transmitter 820 or the long SLIV component 830, the the long SLIV component 830 transmits, to the network node, uplink data via the allocated PUSCH resources in accordance with the group of FH intervals.

FIG. 9 is a flow diagram illustrating an example of a process 900 for frequency hopping across PUSCH resources allocated by a long SLIV, in accordance with various aspects of the present disclosure. The process 900 may be performed by a UE such as a UE 120 described with respect to FIGS. 1, 2, and 4. The process 900 begins at block 902 by receiving, from a network node, a first DCI message that includes a long SLIV indicating an allocation of PUSCH resources to a group of slots. The allocation of PUSCH resources is irrespective of slot boundaries of the group of slots and the PUSCH resources include a set of symbols. At block 904, the process 900 receives, from the network node, a first RRC message configuring a group of FH intervals associated with the long SLIV. Each FH interval may be associated with a respective subset of symbols of the set of symbols. At block 906, the process 900 transmits, to the network node, uplink data via the allocated PUSCH resources in accordance with the group of FH intervals.

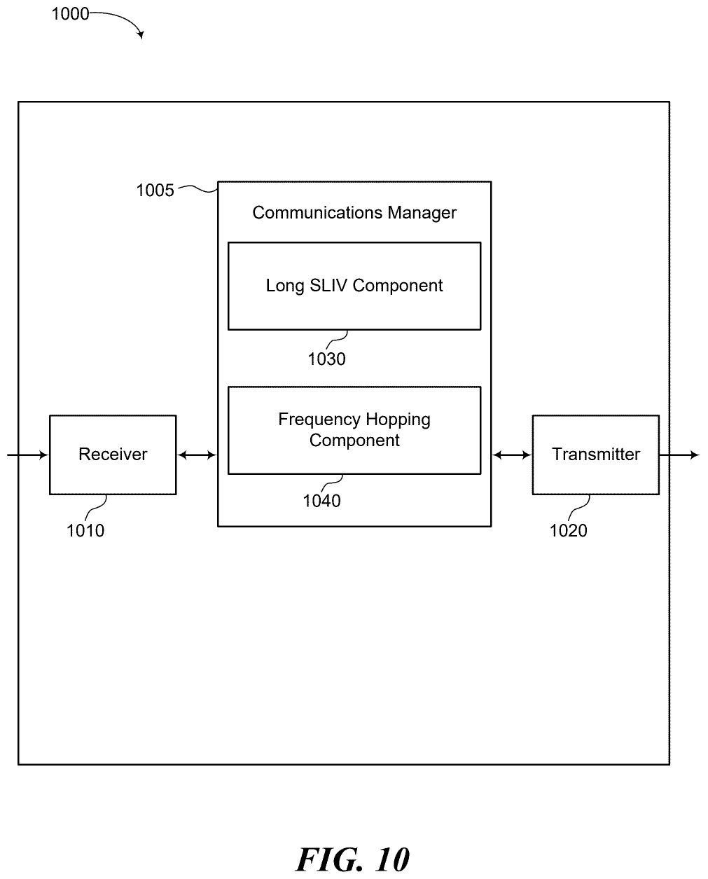

FIG. 10 is a block diagram illustrating an example wireless communication device 1000 that supports frequency hopping intervals, in accordance with various aspects of the present disclosure. The wireless communication device 1000 may be an example of aspects of network node, such as a base station 110 described with reference to FIGS. 1 and 2, a DU 330, an RU 340, or a CU 310 described with reference to FIG. 3, or a network node 400 described with reference to FIG. 4. The wireless communication device 1000 may include a receiver 1010, a communications manager 1005, a transmitter 1020, a long SLIV component 1030, and a frequency hopping component 1040, which may be in communication with one another (for example, via one or more buses). In some examples, the wireless communication device 1000 is configured to perform operations, including operations of the process 1100 described below with reference to FIG. 11.

In some examples, the wireless communication device 1000 can include a chip, chipset, package, or device that includes at least one processor and at least one modem (for example, a 5G modem or other cellular modem). In some examples, the communications manager 1005, or its sub-components, may be separate and distinct components. In some examples, at least some components of the communications manager 1005 are implemented at least in part as software stored in a memory. For example, portions of one or more of the components of the communications manager 1005 can be implemented as non-transitory code executable by the processor to perform the functions or operations of the respective component.

The receiver 1010 may receive one or more of reference signals (for example, periodically configured CSI-RSs, aperiodically configured CSI-RSs, or multi-beam-specific reference signals), synchronization signals (for example, synchronization signal blocks (SSBs)), control information and data information, such as in the form of packets, from one or more other wireless communication devices via various channels including control channels (for example, a PUCCH, or PSCCH) and data channels (for example, a PUSCH, PSSCH). The other wireless communication devices may include, but are not limited to, a UE 120 described with reference to FIGS. 1, 2, and 4.

The received information may be passed on to other components of the wireless communication device 1000. The receiver 1010 may be an example of aspects of the receive processor 238 described with reference to FIG. 2. The receiver 1010 may include a set of radio frequency (RF) chains that are coupled with or otherwise utilize a set of antennas (for example, the set of antennas may be an example of aspects of the antennas 234 described with reference to FIG. 2).

The transmitter 1020 may transmit signals generated by the communications manager 1005 or other components of the wireless communication device 1000. In some examples, the transmitter 1020 may be collocated with the receiver 1010 in a transceiver. The transmitter 1020 may be an example of aspects of the transmit processor 220 described with reference to FIG. 2. The transmitter 1020 may be coupled with or otherwise utilize a set of antennas (for example, the set of antennas may be an example of aspects of the antennas 234 described with reference to FIG. 2), which may be antenna elements shared with the receiver 1010. In some examples, the transmitter 1020 is configured to transmit control information in a PUCCH or PSCCH, and data in a physical uplink shared channel (PUSCH) or PSSCH.

The communications manager 1005 may be an example of aspects of the controller/processor 240 described with reference to FIG. 2. The communications manager 1005 may include the long SLIV component 1030, and a frequency hopping component 1040. In some examples, working in conjunction with the transmitter 1020, the long SLIV component 1030 transmits a first DCI message that includes a long SLIV indicating an allocation of PUSCH resources to a group of slots. The allocation of PUSCH resources may be irrespective of slot boundaries of the group of slots and the PUSCH resources include a set of symbols. Additionally, working in conjunction with the transmitter 1020, the frequency hopping component 1040 transmits a first RRC message configuring a group of FH intervals associated with the long SLIV. Each FH interval may be associated with a respective subset of symbols of the set of symbols. Furthermore, working in conjunction with one or more of the receiver 1010, the long SLIV component 1030, and the frequency hopping component 1040, the communications manager 1005 receives, from a UE, uplink data via the allocated PUSCH resources in accordance with the group of FH intervals.

FIG. 11 is a flow diagram illustrating an example of a process 1100 for configuring frequency hopping across PUSCH resources allocated by a long SLIV, in accordance with various aspects of the present disclosure. The process 1100 may be performed by a network node, network node, such as a base station 110 described with reference to FIGS. 1 and 2, a DU 330, an RU 340, or a CU 310 described with reference to FIG. 3, or a network node 400 described with reference to FIG. 4. The process 1100 begins at block 1102 by transmitting a first DCI message that includes a long SLIV indicating an allocation of PUSCH resources to a group of slots. The allocation of PUSCH resources may be irrespective of slot boundaries of the group of slots and the PUSCH resources include a set of symbols. At block 1104, the process 1100 transmits a first RRC message configuring a group of FH intervals associated with the long SLIV. Each FH interval may be associated with a respective subset of symbols of the set of symbols. At block 1106, the process 1100 receives, from a UE, uplink data via the allocated PUSCH resources in accordance with the group of FH intervals.

Implementation examples are described in the following numbered clauses:
Clause 1. A method for wireless communication at a UE, comprising: receiving, from a network node, a first DCI message that includes a long SLIV indicating an allocation of PUSCH resources to a group of slots, the allocation of PUSCH resources being irrespective of slot boundaries of the group of slots, the PUSCH resources including a set of symbols; receiving, from the network node, a first RRC message configuring a group of FH intervals associated with the long SLIV, each FH interval being associated with a respective subset of symbols of the set of symbols; and transmitting, to the network node, uplink data via the allocated PUSCH resources in accordance with the group of FH intervals.
Clause 2. The method of Clause 1, wherein: each FH interval of the group of FH intervals is associated with a carrier frequency of a group of carrier frequencies; and adjacent FH intervals of the group of FH intervals are associated with different carrier frequencies.
Clause 3. The method of Clauses 1, wherein: each FH interval of the group of FH intervals includes a group of sub-FH intervals; and each sub-FH interval of the group of sub-FH intervals associated with a respective FH interval, of the group of FH intervals, is associated with a respective carrier frequency of a group of carrier frequencies.
Clause 4. The method of any one of Clauses 1-3, wherein: each pair of adjacent FH intervals of the group of FH intervals is separated by a respective gap; and each FH interval of the group of FH intervals includes one or more respective DMRS symbols.
Clause 5. The method of any one of Clauses 1-4, further comprising receiving, from the network node, a message indicating a quantity of FH intervals included in the group of FH intervals or the duration of each FH interval of the group of FH intervals, wherein the message is a second DCI message or a second RRC message.
Clause 6. The method of Clause 5, wherein each FH interval of the group of FH intervals has a same duration.
Clause 7. The method of Clause 6, wherein each subset of symbols of the set of groups of symbols has a same quantity of symbols regardless of whether one or more respective symbols in each subset of symbols, of the set of groups of symbols, is associated with a gap or an invalid symbol.
Clause 8. The method of Clause 6, further comprising adjusting a quantity of symbols in each subset of symbols of the set of symbols such that each subset of symbols of the set of symbols has a same quantity of valid symbols based on one or more respective symbols of at least one of the subset of symbols being associated with a gap or an invalid symbol.
Clause 9. The method of any one of Clauses 1-8, further comprising receiving, from the network node, a message configuring, for each FH interval of the group of FH intervals, a quantity of DMRS symbols and a respective location of each DMRS symbol within the FH interval.
Clause 10. The method of any one of Clauses 1-9, wherein the RRC message jointly configures a DMRS pattern and the group of FH intervals.
Clause 11. A method for wireless communication at a network node, comprising: transmitting a first DCI message that includes a long SLIV indicating an allocation of PUSCH resources to a group of slots, the allocation of PUSCH resources being irrespective of slot boundaries of the group of slots, the PUSCH resources including a set of symbols; transmitting a first RRC message configuring a group of FH intervals associated with the long SLIV, each FH interval being associated with a respective subset of symbols of the set of symbols; and receiving, from a UE, uplink data via the allocated PUSCH resources in accordance with the group of FH intervals.
Clause 12. The method of Clause 11, wherein: each FH interval of the group of FH intervals is associated with a carrier frequency of a group of carrier frequencies; and adjacent FH intervals of the group of FH intervals are associated with different carrier frequencies.
Clause 13. The method of Clause 11, wherein: each FH interval of the group of FH intervals includes a group of sub-FH intervals; and each sub-FH interval of the group of sub-FH intervals associated with a respective FH interval, of the group of FH intervals, is associated with a respective carrier frequency of a group of carrier frequencies.
Clause 14. The method of any one of Clauses 11-13, wherein: each pair of adjacent FH intervals of the group of FH intervals is separated by a respective gap; and each FH interval of the group of FH intervals includes one or more respective DMRSs.
Clause 15. The method of any one of Clauses 11-14, further comprising transmitting a message indicating a quantity of FH intervals included in the group of FH intervals or the duration of each FH interval of the group of FH intervals, wherein the message is a second DCI message or a second RRC message.
Clause 16. The method of Clause 15, wherein each FH interval of the group of FH intervals has a same duration.
Clause 17. The method of Clause 16, wherein each subset of symbols of the set of groups of symbols has a same quantity of symbols regardless of whether one or more respective symbols in each subset of symbols, of the set of groups of symbols, is associated with a gap or an invalid symbol.
Clause 18. The method of any one of Clauses 11-17, further comprising transmitting a message configuring, for each FH interval of the group of FH intervals, a quantity of DMRS symbols and a respective location of each DMRS symbol within the FH interval.
Clause 19. The method of any one of Clauses 11-18, wherein the RRC message jointly configures a DMRS pattern and the group of FH intervals.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (for example, a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (for example, related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method for wireless communication at a user equipment (UE), comprising:
receiving, from a network node, a first downlink control information (DCI) message that includes a long start and length indicator value (SLIV) indicating an allocation of physical uplink shared channel (PUSCH) resources to a group of slots, the allocation of PUSCH resources being irrespective of slot boundaries of the group of slots, the PUSCH resources including a set of symbols;
receiving, from the network node, a first radio resource control (RRC) message configuring a group of frequency hop (FH) intervals associated with the long SLIV, each FH interval being associated with a respective subset of symbols of the set of symbols; and
transmitting, to the network node, uplink data via the allocated PUSCH resources in accordance with the group of FH intervals.

2. The method of claim 1, wherein:
each FH interval of the group of FH intervals is associated with a carrier frequency of a group of carrier frequencies; and
adjacent FH intervals of the group of FH intervals are associated with different carrier frequencies.

3. The method of claim 1, wherein:
each FH interval of the group of FH intervals includes a group of sub-FH intervals; and
each sub-FH interval of the group of sub-FH intervals associated with a respective FH interval, of the group of FH intervals, is associated with a respective carrier frequency of a group of carrier frequencies.

4. The method of claim 1, wherein:
each pair of adjacent FH intervals of the group of FH intervals is separated by a respective gap; and
each FH interval of the group of FH intervals includes one or more respective demodulation reference signal (DMRS) symbols.

5. The method of claim 1, further comprising receiving, from the network node, a message indicating a quantity of FH intervals included in the group of FH intervals or a duration of each FH interval of the group of FH intervals, wherein the message is a second DCI message or a second RRC message.

6. The method of claim 5, wherein each FH interval of the group of FH intervals has a same duration.

7. The method of claim 6, wherein each subset of symbols of the set of symbols has a same quantity of symbols regardless of whether one or more respective symbols in each subset of symbols, of the set of symbols, is associated with a gap or an invalid symbol.

8. The method of claim 6, further comprising adjusting a quantity of symbols in each subset of symbols of the set of symbols such that each subset of symbols of the set of symbols has a same quantity of valid symbols based on one or more respective symbols of at least one of the subset of symbols being associated with a gap or an invalid symbol.

9. The method of claim 1, further comprising receiving, from the network node, a message configuring, for each FH interval of the group of FH intervals, a quantity of demodulation reference signal (DMRS) symbols and a respective location of each DMRS symbol within the FH interval.

10. The method of claim 1, wherein the RRC message jointly configures a demodulation reference signal (DMRS) pattern and the group of FH intervals.

11. A user equipment (UE) comprising:
one or more processors; and
one or more memories coupled with the one or more processors and storing processor-executable code that, when executed by the one or more processors, is configured to cause the UE to:
receive, from a network node, a first downlink control information (DCI) message that includes a long start and length indicator value (SLIV) indicating an allocation of physical uplink shared channel (PUSCH) resources to a group of slots, the allocation of PUSCH resources being irrespective of slot boundaries of the group of slots, the PUSCH resources including a set of symbols;
receive, from the network node, a first radio resource control (RRC) message configuring a group of frequency hop (FH) intervals associated with the long SLIV, each FH interval being associated with a respective subset of symbols of the set of symbols; and
transmit, to the network node, uplink data via the allocated PUSCH resources in accordance with the group of FH intervals.

12. The UE of claim 11, wherein:
each FH interval of the group of FH intervals is associated with a carrier frequency of a group of carrier frequencies; and
adjacent FH intervals of the group of FH intervals are associated with different carrier frequencies.

13. The UE of claim 11, wherein:
each FH interval of the group of FH intervals includes a group of sub-FH intervals; and
each sub-FH interval of the group of sub-FH intervals associated with a respective FH interval, of the group of FH intervals, is associated with a respective carrier frequency of a group of carrier frequencies.

14. The UE of claim 11, wherein:
each pair of adjacent FH intervals of the group of FH intervals is separated by a respective gap; and
each FH interval of the group of FH intervals includes one or more respective demodulation reference signal (DMRSs) symbols.

15. The UE of claim 11, wherein execution of the processor-executable code further causes the UE to receive, from the network node, a message indicating a quantity of FH intervals included in the group of FH intervals or a duration of each FH interval of the group of FH intervals, wherein the message is a second DCI message or a second RRC message.

16. A method for wireless communication at a network node, comprising:
transmitting a first downlink control information (DCI) message that includes a long start and length indicator value (SLIV) indicating an allocation of physical uplink shared channel (PUSCH) resources to a group of slots, the allocation of PUSCH resources being irrespective of slot boundaries of the group of slots, the PUSCH resources including a set of symbols;
transmitting a first radio resource control (RRC) message configuring a group of frequency hop (FH) intervals associated with the long SLIV, each FH interval being associated with a respective subset of symbols of the set of symbols; and
receiving, from a user equipment (UE), uplink data via the allocated PUSCH resources in accordance with the group of FH intervals.

17. The method of claim 16, wherein:
each FH interval of the group of FH intervals is associated with a carrier frequency of a group of carrier frequencies; and
adjacent FH intervals of the group of FH intervals are associated with different carrier frequencies.

18. The method of claim 16, wherein:
each FH interval of the group of FH intervals includes a group of sub-FH intervals; and
each sub-FH interval of the group of sub-FH intervals associated with a respective FH interval, of the group of FH intervals, is associated with a respective carrier frequency of a group of carrier frequencies.

19. The method of claim 16, wherein:
each pair of adjacent FH intervals of the group of FH intervals is separated by a respective gap; and
each FH interval of the group of FH intervals includes one or more respective demodulation reference signal (DMRS) symbols.

20. The method of claim 16, further comprising transmitting a message indicating a quantity of FH intervals included in the group of FH intervals or a duration of each FH interval of the group of FH intervals, wherein the message is a second DCI message or a second RRC message.

21. The method of claim 20, wherein each FH interval of the group of FH intervals has a same duration.

22. The method of claim 21, wherein each subset of symbols of the set of symbols has a same quantity of symbols regardless of whether one or more respective symbols in each subset of symbols, of the set of symbols, is associated with a gap or an invalid symbol.

23. The method of claim 16, further comprising transmitting a message configuring, for each FH interval of the group of FH intervals, a quantity of demodulation reference signal (DMRS) symbols and a respective location of each DMRS symbol within the FH interval.

24. The method of claim 16, wherein the RRC message jointly configures a demodulation reference signal (DMRS) pattern and the group of FH intervals.

25. A network node, comprising:
one or more processors; and
one or more memories coupled with the one or more processors and storing processor-executable code that, when executed by the one or more processors, is configured to cause the network node to:
transmit a first downlink control information (DCI) message that includes a long start and length indicator value (SLIV) indicating an allocation of physical uplink shared channel (PUSCH) resources to a group of slots, the allocation of PUSCH resources being irrespective of slot boundaries of the group of slots, the PUSCH resources including a set of symbols;
transmit a first radio resource control (RRC) message configuring a group of frequency hop (FH) intervals associated with the long SLIV, each FH interval being associated with a respective subset of symbols of the set of symbols; and
receive, from a user equipment (UE), uplink data via the allocated PUSCH resources in accordance with the group of FH intervals.

26. The network node of claim 25, wherein:
each FH interval of the group of FH intervals is associated with a carrier frequency of a group of carrier frequencies; and
adjacent FH intervals of the group of FH intervals are associated with different carrier frequencies.

27. The network node of claim 25, wherein:
each FH interval of the group of FH intervals includes a group of sub-FH intervals; and
each sub-FH interval of the group of sub-FH intervals associated with a respective FH interval, of the group of FH intervals, is associated with a respective carrier frequency of a group of carrier frequencies.

28. The network node of claim 25, wherein:
each pair of adjacent FH intervals of the group of FH intervals is separated by a respective gap; and
each FH interval of the group of FH intervals includes one or more respective demodulation reference signal (DMRS) symbols.

29. The network node of claim 25, wherein execution of the processor-executable code further causes the network node to transmit a message indicating a quantity of FH intervals included in the group of FH intervals or a duration of each FH interval of the group of FH intervals, wherein the message is a second DCI message or a second RRC message.

30. The network node of claim 29, wherein each FH interval of the group of FH intervals has a same duration.
